(19) United States
(12) Patent Application Publication
(10) Pub. No.: US 2004/0167345 A1
(43) Pub. Date: Aug. 26, 2004

(54) Method for preparing bismuth tris-trifluoromethanesulphonate

(76) Inventors: Christophe Leroux, Chateauroux (FR); Sigrid Repichet, Monsempron-Libos (FR); Jacques Dubac, Pescbusque (FR)

Correspondence Address: YOUNG & THOMPSON, 745 SOUTH 23RD STREET 2ND FLOOR, ARLINGTON, VA, 22202

(21) Appl. No.: 10/220,493

(22) PCT Filed: Mar. 2, 2001
(86) PCT No.: PCT/FR01/00630

(30) Foreign Application Priority Data
Mar. 3, 2000 (FR) 00/02781

(51) Int. Cl. C07F 9/94

(52) U.S. Cl. 556/76

(57) ABSTRACT

A method for preparing bismuth tris-trifluoromethanesulphonate, characterized in that it consists in reacting CF₃SO₃H trifluoromethanesulphonic acid with Bi₂O₃ bismuth trioxide in a medium consisting of a water/alcohol mixture, and in recuperating the resulting bismuth tris-trifluoromethanesulphonate.

The present invention relates to a novel process for the preparation of bismuth tris(trifluoromethanesulfonate).

Bismuth tris(trifluoromethanesulfonate), often denoted under the trivial name of bismuth triflate, is the compound of formula Bi(OSO₂CF₃)₃, also recorded as Bi(OTf)₃.

Generally, metal triflates are known as being particularly advantageous Lewis acids which are employed in particular as catalysts in numerous reactions, especially in the field of organic chemistry. Reference may be made, on this subject, to, for example, the articles by Kobayashi in Synlett., pages 689-701 (1994), by Marshman in Aldrichimica Acta, volume 28, pages 77-84 (1995), by Noyori et al. in Tetrahedron, volume 37, pages 3899-3910 (1981), or by Olah et al. in Journal of the American Chemical Society, volume 110, pages 2560-2565 (1988).

Bismuth triflate Bi(OTf)₃ exhibits the advantageous distinctive feature of being stable in water. This specific characteristic allows it to be used in catalyses in an aqueous medium, which has, inter alia, the two-fold advantage that the reactions are carried out in an environmentally-friendly medium and that the catalyst can be recycled on conclusion of the reaction.

Furthermore, it should be emphasized that bismuth is the least toxic of the heavy elements, unlike in particular lead, mercury or thallium. Furthermore, in contrast to rare-earth metals, for example, bismuth is inexpensive. In terms of cost, of toxicity and of repercussions on the environment, Bi(OTf)₃ therefore constitutes one of the best metal triflates which can be used in catalysis.

For this reason, Bi(OTf)₃ can be used industrially, in particular in the catalysis of Friedel-Crafts reactions and especially for producing large tonnages of aromatic ketones, as is disclosed, for example, in patent applications WO 98/40339 or WO 97/11930.

However, current processes for the synthesis of Bi(OTf)₃ are relatively difficult and expensive. This is because, in order to obtain Bi(OTf)₃ quantitatively, conventional processes generally carry out the reaction of a large excess of trifluoromethanesulfonic acid and/or of trifluoromethanesulfonic anhydride with a bismuth compound, such as, in particular, bismuth oxide or its derivatives, such as, for example, bismuth tris(trifluoroacetate).

In point of fact, trifluoromethanesulfonic acid TfOH, also known as triflic acid, is an expensive product, as is the corresponding trifluoromethanesulfonic anhydride Tf₂O (triflic anhydride).

Furthermore, the reactions for the synthesis of Bi(OTf)₃ employing these compounds often require relatively long reaction times.

Furthermore, the use of bismuth derivatives other than bismuth oxide leads to the production of byproducts which can present problems in terms of purification of the final product and possibly of repercussions on the environment.

It has now been discovered that the use of the reaction of triflic acid TfOH with bismuth trioxide Bi₂O₃ in a water/alcohol mixture results, surprisingly, in a quantitative reaction of the acid with the oxide, this taking place under mild conditions and with relatively short reaction times in comparison with the other known processes.

On the basis of this discovery, a first aim of the present invention is to provide a process for the preparation of bismuth triflate having a high yield, without the use of a large excess of triflic reactant being necessary.

A second aim of the invention consists in providing a method for the synthesis of Bi(OTf)₃ requiring a reduced reaction time.

Another aim of the present invention is to provide a process for the synthesis of bismuth triflate which is advantageous both in terms of costs and of repercussions on the environment.

The subject matter of the present invention is thus a process for the preparation of bismuth tris (trifluoromethanesulfonate) characterized in that trifluoromethanesulfonic acid CF₃SO₃H is reacted with bismuth trioxide Bi₂O₃ in a medium composed of a water/alcohol mixture and in that the bismuth tris(trifluoromethanesulfonate) obtained is recovered.

More specifically, the process of the invention employs the reaction with the following balanced equation:

Bi₂O₃+6TfOH→2Bi(OTf)₃+3H₂O (equation I)

This reaction of triflic acid with bismuth oxide employed according to the invention is advantageously carried out in a medium composed of a mixture of water and of an alcohol.

In this respect, it should be noted that, because of the use of an aqueous/alcoholic reaction medium in the process of the invention, the bismuth triflate obtained on conclusion of the stage of reaction of TfOH with Bi₂O₃ is specifically a bismuth triflate in a hydrated form.

The alcohol employed in the reaction mixture is advantageously a water-miscible alcohol having from 1 to 3carbon atoms.

In particular because of its low cost and its low toxicity, the alcohol preferably used in the water/alcohol mixture employed in the process of the invention is ethanol. Furthermore, it should also be noted that the use of ethanol leads to particularly advantageous results in terms of reaction rate and yield.

Generally, to obtain both a high yield and a satisfactory reaction rate for the reaction of TfOH and of Bi₂O₃, the alcohol, whatever it is, is generally present as the predominant component in the specific water/alcohol mixture employed.

More specifically, the alcohol/water ratio by volume in the starting reaction medium, drawn up on the basis of the volumes measured before mixing, is advantageously between 50:50 and 90:10, preferably between 60:40 and 80:20. In a particularly preferred way, this ratio by volume has a value close to the ratio 75:25.

The use of the specific water/alcohol mixture as reaction medium makes it possible to employ triflic acid and bismuth trioxide in proportions close to the stoichiometery corresponding to the equation I.

In fact, the reactants are generally employed in the process of the invention with a starting TfOH/Bi₂O₃ molar ratio close to 6:1, that is to say advantageously between 6:1 and 6.5:1 and preferably between 6:1 and 6.1:1.

Furthermore, so as to result in optimum conditions in terms of reaction rate and yield, the content of Bi₂O₃ in the starting suspension is generally between 40 and 80 g/l and preferably between 50 and 70 g/l.

Likewise, the starting concentration of triflic acid in the medium is advantageously between 70 and 150 g/l and preferably between 100 and 130 g/l.

It should also be noted that, in view of the solid state of the bismuth trioxide and of its immiscibility in the water/alcohol reaction medium, the reaction is generally carried out with stirring, so as to form a starting suspension and to optimize solid/liquid contacts during the reaction.

Furthermore, so as to obtain a high yield with a relatively short reaction time, the reaction of TfOH with Bi₂O₃ is generally carried out at a temperature of between 40 and 75° C. and preferably between 60 and 70° C.

Under the abovementioned conditions of concentrations and of temperature, the reaction times observed for the reaction of triflic acid with bismuth trioxide are generally between 2 hours and 6 hours. For this reason, the reaction employed in the process of the invention is generally carried out for a period of time ranging from 2 hours to 4 hours.

The yield of the reaction for the conversion of Bi₂O₃ to Bi(OTf)₃ observed during the use of the specific water/alcohol mixture as reaction medium is generally greater than or equal to 97%.

Furthermore, in addition to these advantages in terms of reaction rate and yield, the process of the invention also exhibits the following advantages:

the reaction used for the synthesis of Bi(OTf)₃ does not result in the formation of byproducts, apart from water. If, in addition, the use of a mixture of water/alcohol type as reaction medium is taken into account, it is apparent that the process of the invention is in line with the respect of the environment;

the reaction conditions (low temperature, solvents of low toxicity, indeed even nontoxic solvents) also result in a process which is advantageous from the safety viewpoint;

the isolation of the reaction product can, because of the absence of byproduct and of the use of the specific water/alcohol mixture, be carried out using well known techniques which are simple and inexpensive to implement, such as, for example, evaporation of the solvents and lyophilization.

In fact, the bismuth triflate produced during the reaction of TfOH and Bi₂O₃ is generally recovered by removing the solvent and purifying the product, in particular by evaporation and lyophilization. The bismuth tris(trifluoromethanesulfonate) thus recovered is generally obtained in a hydrated form.

The subject matter of the invention will become even more clearly apparent in the light of the illustrative example set out below.

### EXAMPLE

2.293 g (4.921 mmol) of bismuth trioxide Bi₂O₃ were introduced into a round-bottomed flask. 35 ml of an ethanol+water mixture characterized by an ethanol/water ratio by volume of 75:25 were subsequently added. 4.452 g (29.666 mmol) of triflic acid were subsequently added.

A yellow suspension was then obtained, which suspension was stirred at a temperature of 65° C. for a time of 3 hours, until a milky white solution was obtained.

The solvents (water and ethanol) were subsequently removed under reduced pressure. The white solid obtained on conclusion of this stage of removal of solvent was then dissolved in 30 ml of distilled water and subjected to a lyophilization operation in a freeze dryer of Christ Alpha 2-4 type (pressure of 0.035 mbar (3 500 Pa)), with a refrigeration temperature of −83° C.

In this way, 6.727 g of a white solid were recovered.

The solid obtained exhibits the same spectroscopic characteristics (carbon and fluorine Nuclear Magnetic Resonance; InfraRed spectroscopy) as a reference sample of Bi(OTf)₃ prepared according to the method described in Tetrahedron Letters, volume 40, pages 285-286 (1999), that is to say the following characteristics:

¹³C NMR (50.3 MHz, d₆-acetone): δ=120 ppm (TMS reference) (quad., ¹J_{13C/19F}=321 Hz);

¹⁹F NMR (75.4 MHz, d₆-acetone): δ=0.84 ppm (CF₃COOH reference);

InfraRed (nujol): ν=3450-3550 cm⁻¹ (m), 1230-1290 (vs), 1180 (s), 1034 (s), 1028 (sh), 650 (sh), 643 (s).

The analysis by X-ray diffractometry of the white powder obtained (recorded on a high resolution diffractometer of Siemens D500 type using the Kα₁ line of copper) at a temperature of 45° C. is furthermore in agreement with the structure of bismuth triflate tetrahydrate [Bi(OTf)₃.4H₂O] published in particular in Chemical Materials, volume 9, pages 3012-3016 (1997). The mass obtained (6.727 g) corresponds to a degree of hydration by mass of 7%. This degree of hydration of the bismuth triflate obtained is estimated by proton Nuclear Magnetic Resonance (solvent d₈-THF) by measuring the amount of water present in a known mass of bismuth triflate (δ=11.3 ppm), taking the signal of a known amount of iodoform (δ=5.2 ppm) as reference. Thus, the yield of this reaction, defined by the ratio of the number of moles of bismuth triflate obtained to two times the number of moles of bismuth trioxide introduced, is equal to 97%.

1. A process for the preparation of bismuth tris(trifluoromethanesulfonate), characterized in that trifluoromethanesulfonic acid CF₃SO₃H is reacted with bismuth trioxide Bi₂O₃ in a medium composed of a water/alcohol mixture and in that the bismuth tris(trifluoromethanesulfonate) obtained is recovered.

2. The process for the preparation of bismuth tris(trifluoromethanesulfonate) as claimed in claim 1, characterized in that the alcohol employed in the reaction medium is a water-miscible alcohol having from 1 to 3 carbon atoms.

3. The process for the preparation of bismuth tris(trifluoromethanesulfonate) as claimed in claim 1 or claim 2, characterized in that the alcohol employed in the reaction medium is ethanol.

4. The process for the preparation of bismuth tris(trifluoromethanesulfonate) as claimed in any one of claims 1 to 3, characterized in that the alcohol/water ratio by volume in the reaction medium is initially between 50:50 and 90:10.

5. The process for the preparation of bismuth tris(trifluoromethanesulfonate) as claimed in any one of claims 1 to 4, characterized in that the alcohol/water ratio by volume in the reaction medium is initially between 60:40 and 80:20.

6. The process for the preparation of bismuth tris(trifluoromethanesulfonate) as claimed in any one of claims 1 to 5, characterized in that the trifluoromethanesulfonic acid and the bismuth trioxide are employed with a starting CF₃SO₃H/Bi₂O₃ molar ratio of between 6:1 and 6.5:1.

7. The process for the preparation of bismuth tris(trifluoromethanesulfonate) as claimed in any one of claims 1 to 6, characterized in that the starting content of Bi₂O₃ in the reaction medium is between 40 and 80 g/l.

8. The process for the preparation of bismuth tris(trifluoromethanesulfonate) as claimed in any one of claims 1 to 7, characterized in that the starting concentration of triflic acid in the reaction medium is between 70 and 150 g/l.

9. The process for the preparation of bismuth tris(trifluoromethanesulfonate) as claimed in any one of claims 1 to 8, characterized in that the reaction of triflic acid with bismuth trioxide is carried out at a temperature of between 40 and 75° C.

10. The process for the preparation of bismuth tris(trifluoromethanesulfonate) as claimed in any one of claims 1 to 9, characterized in that said recovered bismuth tris(trifluoromethanesulfonate) is obtained in a hydrated form.
